(19) United States
(12) Patent Application Publication
(10) Pub. No.: US 2018/0376213 A1
(43) Pub. Date: Dec. 27, 2018

(54) ASSOCIATION BETWEEN A CLIENT AND A MULTIMEDIA DEVICE

(71) Applicant: THOMSON Licensing, Issy-les-Moulineaux (FR)

(72) Inventor: Thomas WALSH, Somerset, NJ (US)

(73) Assignee: THOMSON Licensing, Issy-les-Moulineaux (FR)

(21) Appl. No.: 15/775,118

(22) PCT Filed: Nov. 10, 2015
(86) PCT No.: PCT/US15/59858

§ 371 Date: May 10, 2018

(51) Int. Cl. H04N 21/472; H04N 21/41; H04N 21/482; H04N 21/84; H04N 21/643

(52) U.S. Cl. CPC H04N 21/47202; H04N 21/4126; H04N 21/64322; H04N 21/84; H04N 21/482

(57) ABSTRACT

A client device interacts with an interface device to provide an identifier for multimedia content control. The identifier received from the client device is then associated with a multimedia device. The client device transmits commands associated with multimedia content access and/or controls that are then forwarded 5 to the multimedia device, making the client device compatible, for multimedia control, with the multimedia device. Multimedia control commands are executed in the multimedia device based at least partially on commands from the client device.

### TECHNICAL FIELD

The present principles relate to multimedia devices. In particular, the present principles relate to control of media content.

### BACKGROUND

Multimedia streaming over various networks is becoming increasingly popular. Multimedia streaming can include, for example, streaming movies, TV shows, and music. Video On Demand (VOD) allows users to watch or listen to multimedia content at any time that is convenient for the user. Internet Protocol (IP) television can be used to bring VOD to a television, personal computer, or device.

### SUMMARY

As noted above, multimedia streaming over various networks is becoming increasingly popular. Unfortunately, the equipment required for VOD services at, for example, hotels, hospitals, or nursing homes can be expensive and/or difficult to maintain. Such establishments can distribute a television signal via a coaxial network to a set-top box placed in each room. These establishments can also provide entertainment using a Satellite Master Antenna TV (“SMATV”) system. In a satellite system, a television signal can be sent from the satellite dish to a master receiver comprising part of premises-based distribution system which, in turn, forwards the signal to a set top box in each room via a coaxial network. The set top box can then decrypt the signal. As noted above, the equipment and wiring of these systems can be costly; furthermore, troubleshooting these systems can be tedious and time consuming.

In view of the foregoing, disclosed herein are systems, apparatus, and methods for multimedia streaming. In one example, a system can comprise an interface device and an access control device. The interface device can communicate with a client device. The access control device can detect an identifier associated with the client device, the identifier being received from the client device via the interface. The access control device can further associate the identifier with a multimedia device. The access control device can also execute commands in the multimedia device based at least partially on commands received from the client device by the interface.

In a further aspect, the multimedia device can be a dongle connected to a display device. The access control device can select the multimedia device that can be associated with the identifier. The access control device can further communicate with a server to determine and configure client device access permissions for multimedia content. The access control device can also scan a quick response code displayed by the client device in order to detect the identifier.

In a further aspect, an apparatus is provided. The apparatus can comprise an interface and at least one processor configured to detect an identifier associated with the client device, the identifier being received from the client device via the interface; associate the identifier with a multimedia device; and execute commands in the multimedia device based at least partially on commands received from the client device by the interface.

In yet another example, a method can include communicating with a client device using an interface device. The method can further include detecting, by at least one processor, an identifier associated with the client device, the identifier being received from the client device via the interface. Detection of the identifier can include scanning, by the at least one processor, a quick response code displayed by the client device. The method can also include associating, by the at least one processor, the identifier with a multimedia device. Moreover, the method can include executing, by the at least one processor, commands in the multimedia device based at least partially on commands received from the client device by the interface.

In a further example, the method can include selecting, by the at least one processor, the multimedia device that will be associated with the identifier; and communicating, by the at least one processor, with a server to determine and configure client device access permissions for multimedia content.

In an alternative example, an apparatus can comprise an interface device and at least one processor. The at least one processor can transmit, via the interface device, to an access controller, an identifier associated with the apparatus. The at least one processor can further receive, via the interface device, an acknowledgement that the identifier is associated with a multimedia device. The at least one processor can also transmit, via the interface device, commands to the associated multimedia device via the access controller.

In another aspect, the at least one processor can select the multimedia device that will be associated with the identifier and display a quick response code indicative of the identifier associated with the apparatus.

In yet another example, a method can include transmitting, by at least one processor, an identifier associated with a client device to an access controller. The method can further include detecting, by the at least one processor, an acknowledgement from the access controller that the identifier is associated with a multimedia device. The method can also include transmitting, by the at least one processor, commands to the associated multimedia device via the access controller.

In another example, the method can include selecting, by the at least one processor, the multimedia device that will be associated with the identifier; and displaying, by the at least one processor, a quick response code indicative of the identifier associated with the client device.

Thus, rather than buying proprietary equipment that is expensive to purchase and maintain, the system disclosed herein can be implemented using network infrastructure that is significantly more economical. Furthermore, users can be enabled to transmit multimedia commands using their personal devices. Such commands can include, for example, selecting multimedia content, changing channels, and the like.

The aspects, features and advantages of the present principles will be appreciated when considered with reference to the following description of examples and accompanying figures. The following description does not limit the present principles; rather, the scope of the present principles are defined by the appended claims and equivalents.

### BRIEF DESCRIPTION OF THE DRAWINGS

FIG. 1 is an exemplary apparatus for controlling media content in accordance with an embodiment of the present principles.

FIG. 2 is an exemplary VOD system for controlling media content in accordance with an embodiment of the present principles.

FIG. 3 is a flow diagram of an exemplary method for controlling media content in accordance with an embodiment of the present principles.

FIG. 4 is a working example in a hotel environment for controlling media content in accordance with an embodiment of the present principles.

FIG. 5 is a further flow diagram of an exemplary method for controlling media content in accordance with an embodiment of the present principles.

FIG. 6 is a further working example in a home setting for controlling media content in accordance with an embodiment of the present principles.

### DETAILED DESCRIPTION

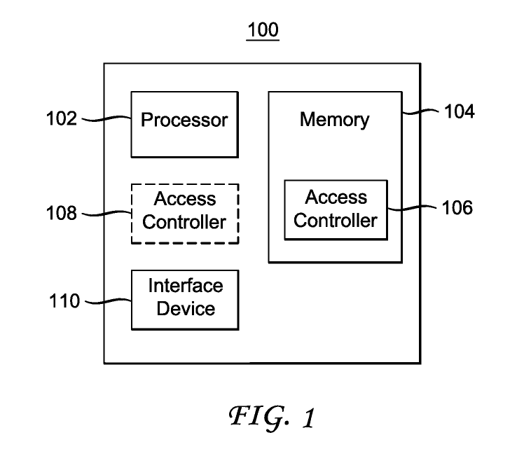

FIG. 1 presents a schematic diagram of an illustrative computer apparatus 100 that can be used as a server or a client in accordance with the present principles. The computer apparatus 100 can comprise, as non-limiting examples, any device capable of processing instructions and transmitting data to and from other computers, including a laptop, a full-sized personal computer, a high-end server, or a network computer lacking local storage capability. The computer apparatus 100 can include all the components normally used in connection with a computer. For example, it can have a keyboard and mouse and/or various other types of input devices, such as pen-inputs, joysticks, buttons, touch screens, etc., as well as a display, which could include, for instance, a CRT, LCD, plasma screen monitor, TV, projector, etc. The computer apparatus 100 can also comprise an interface device 110 to communicate with other devices over a network.

Furthermore, the computer apparatus 100 can be a mobile device that includes, but is not limited to, a smart phone or tablet PC and the like. In this instance, the computer apparatus 100 can include all the components normally used in connection with mobile devices. For example, the computer apparatus 100 can have a touch screen display, a physical keyboard, a virtual touch screen keyboard, a camera, a speaker, a global positioning system, a microphone, and/or a transceiver for transmitting long range and/or short range wireless signals.

The computer apparatus 100 can also contain at least one processor 102 that can be arranged as different processing cores. For ease of illustration, one processor 102 is shown in FIG. 1, but it is understood that multiple processors can be employed simultaneously. The processor 102 can be any number of known processors, including, for example, as processors from Intel® Corporation. In another example, processor 102 can be an application specific integrated circuit (“ASIC”). Processor 102 can be implemented as a hardware processor, a digital signal processor (“DSP”), an ASIC, a field programmable gate array (“FPGA”) or other programmable logic devices, a discrete gate or transistor logic device, a discrete hardware component, or any suitable combination of processing circuitry for executing the functions described in the present principles. The processor 102 can also be implemented as a combination of computation devices, such as a combination of a DSP and a microprocessor, a plurality of microprocessors, one or more microprocessors in communication with the DSP or any other such configuration. The described devices can include processing circuits, processors, FPGAs or ASICs, each of which can be in combination with software for execution.

A memory 104 can store information accessible by the processor 102, including instructions and/or data. The memory 104 can be any type of memory capable of storing information accessible by the processor 102 including, but not limited to, a memory card, read only memory (“ROM”), random access memory (“RAM”), DVD, or other optical disks, as well as other write-capable and read-only memories. The computer apparatus 100 can include different combinations of the foregoing, whereby different portions of the instructions and data are stored on different types of media.

In another example, the memory 104 can be a non-transitory computer readable medium that can include any computer readable media with the exception of a transitory, propagating signal. Examples of non-transitory computer readable media can include one of many physical media such as, for example, electronic, magnetic, optical, electromagnetic, and/or semiconductor media. More specific examples of suitable non-transitory computer-readable media include, but are not limited to, a portable magnetic computer diskette such as floppy diskettes or hard drives, an erasable programmable read-only memory, a portable compact disc or other storage devices that can be coupled to computer apparatus 100 directly or indirectly. The non-transitory computer readable media can also include any combination of one or more of the foregoing and/or other devices as well. While only one memory is shown in FIG. 1, the computer apparatus 100 can actually comprise additional memories that can or cannot be stored within the same physical housing or location.

An interface device 110 can include hardware components (e.g., chipsets, controllers, antennas, etc.) and/or software that allow the computer apparatus 100 to transmit, and/or receive data. The interface device 110 can support one or more network interfaces including, but not limited to, Wi-Fi, worldwide interoperability for microwave access (“WiMAX”), 3rd generation mobile telecommunications (“3G”), code division multiple access (“CDMA”), Ethernet, special protocols proprietary to one or more companies, and various combinations of the foregoing.

An access controller 108 can include processing circuitry for executing access controller functions described further below and an access controller 106 can be a software implementation of the access controller 108 which includes processing circuitry. However, it is understood that the access controller 108, 106 can be implemented in the form of hardware and software combined and that the examples herein are merely illustrative. In the software implementation, the access controller 106 can be encoded in any set of software instructions that are executable directly (such as machine code) or indirectly (such as scripts) by a processor. The computer executable instructions can be stored in any computer language or format, such as in object code or modules of source code.

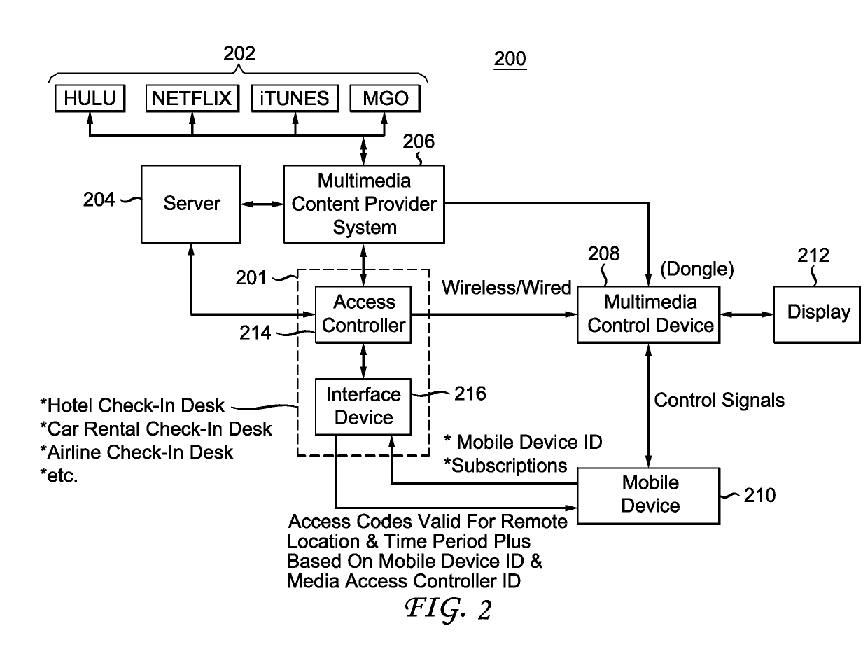

Referring now to FIG. 2, an illustrative VOD system 200 is shown. Multimedia content sources 202 can include a variety of streaming media sources from various streaming media companies. In the example of FIG. 2, the illustrative multimedia sources 202 include Hulu™, Netflix™, iTunes™, and MGO™. Each streaming media source can maintain a content delivery network to distribute and deliver the content. It is understood that such a content delivery network can comprise distributed proxy servers deployed at multiple data centers across the Internet.

The multimedia sources 202 can deliver content to a multimedia content provider system 206 used by an establishment (e.g., hospital, hotel, nursing home, apartment building/condominium or a single family residence, etc.). In turn, multimedia content provider system 206 can redistribute the content within the establishment's VOD system 200, in accordance with the permissions of each end user. The permissions of each user can be stored in a server 204. Multimedia content provider system 206 can provide access to multimedia sources 202 in a streaming session by, for example, buffering each bit stream of the multimedia sources 202. Furthermore, multimedia content provider 206 can store different versions of the multimedia content (e.g., different formats or resolutions of the same content).

Multimedia content provider system 206 can also receive and store associations between mobile devices (e.g., mobile device 210) and multimedia control devices (e.g., multimedia control device 208). These associations can be stored in a database (not shown) as a part of the Multimedia content provider system 206 or as a separate unit. Each mobile device whose identifier is in the database can be permitted to execute commands in a respective multimedia control device. Although the architecture of such a database is not limited by any particular data structure, the data can be stored in computer registers, in a relational database as a table having a plurality of different fields and records, XML documents or flat files. The data can also be formatted in any computer-readable format. The data can comprise any information sufficient to identify the relevant information, such as numbers, descriptive text, proprietary codes, references to data stored in other areas of the same memory or different memories (including other network locations) or information that is used by a function to calculate the relevant data.

In the examples herein, multimedia control device 208 can be a dongle. In one example, such a dongle can be a small hardware component that can be attached to a display (e.g., display 212), a laptop computer, or a PC in a wired or wireless configuration. In a wired configuration, a dongle can be connected to a device using a universal serial bus (“USB”), micro-USB, or High Definition Multimedia Interface (“HDMI”) port. Furthermore, the dongle that makes up multimedia control device 208 can include software or hardware that allows program selection and playback of multimedia content and to connect wirelessly to a multimedia content server, such as multimedia content provider system 206. However, it is understood that multimedia control device 208 can include any other device that can receive and execute multimedia playback commands and permit selection of content. For example, multimedia control device 208 can also include, but is not limited to, a personal computer, a tablet, a set top box, a smart television, or even a mobile phone.

As noted above, the access controller, such as access controller 214, can be implemented in hardware, software, or a combination of hardware and software. In one example, access controller 214 can detect an identifier associated with a client device (e.g., mobile device 210). The identifier can be received from the client device via an interface device (e.g. interface device 216). In a further example, access controller 214 can associate the identifier with a multimedia device (e.g., multimedia control device 208) and execute commands in the multimedia device based at least partially on commands received from the client device by the interface device (e.g. interface device 216). That is, once the association is made, the client device can then control playback of multimedia content via access controller 108. In another example, FIG. 2 also illustrates that the client device can communicate with the multimedia device (e.g., a dongle) directly using a short range wireless protocol (e.g., Bluetooth™).

Display 212 can include, but is not limited to, a CRT, LCD, plasma screen monitor, TV, projector, or any other electronic device that is operable to display information. Display 212 can be integrated with computer apparatus 201 or can be a device separate from computer apparatus 201.

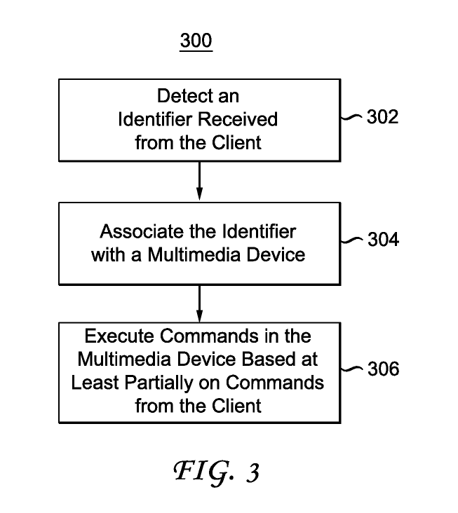

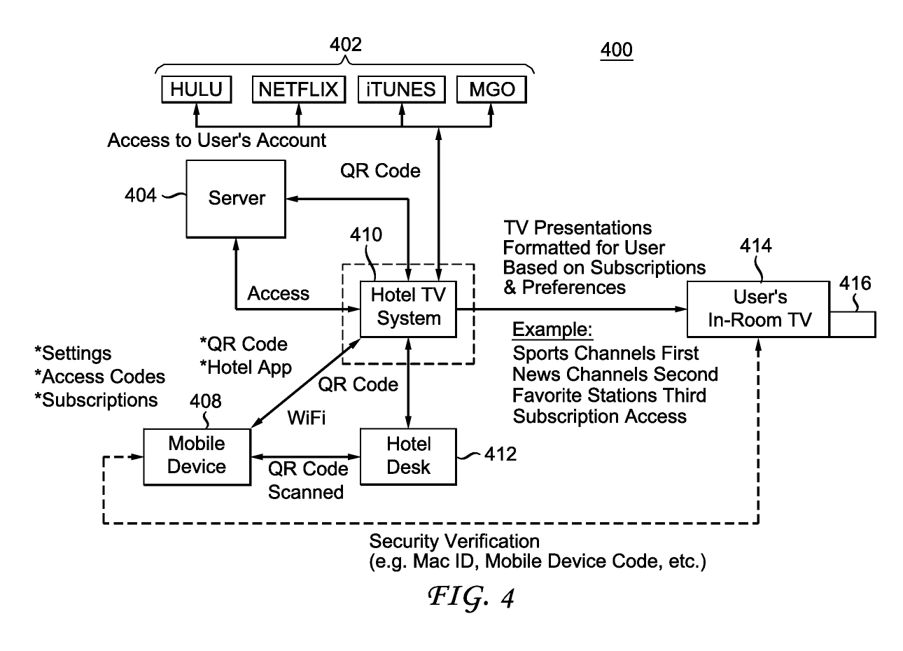

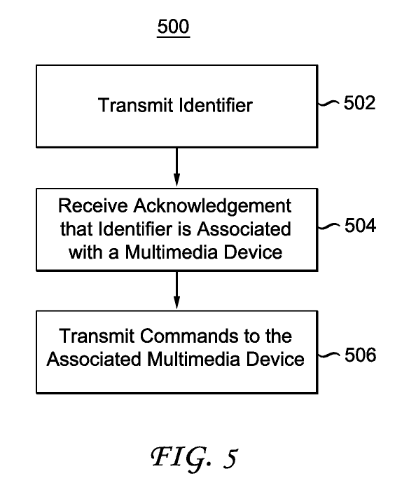

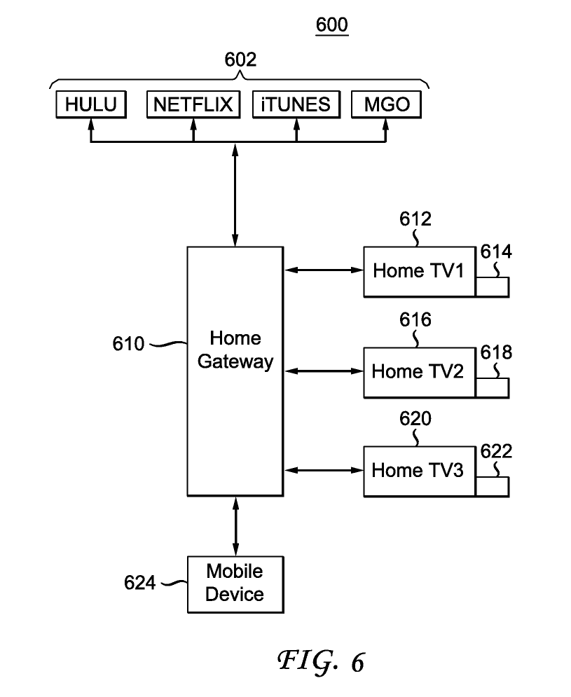

Working examples of the techniques herein are shown in FIGS. 3-6. In particular, FIG. 3 illustrates a flow diagram of an exemplary method 300 for controlling media content from the perspective of an access controller. FIG. 5 illustrates a flow diagram of an exemplary method 500 for controlling media content from the perspective of a mobile device. FIGS. 4 and 6 show working examples 400 and 600 respectively in accordance with aspects of the present principles. The actions shown in FIGS. 4 and 6 will be discussed below with regard to the flow diagrams in FIGS. 3 and 5 respectively.

Referring to FIG. 3, an exemplary method from the perspective of an access controller is shown. In block 302, an identifier received from a client is detected. In FIG. 4, a working example 400 of a hotel VOD system is shown. However, it is understood that the VOD system of FIG. 4 can also be implemented in other settings, such as hospitals or nursing homes, apartment buildings/condominiums or single family residences, for example. It is further understood that airlines can implement the VOD system disclosed herein in airplanes to provide in-flight entertainment and that car rental agencies can implement the present system to provide VOD in rental cars and also control preferential settings desired by a car rental customer such as, for example, GPS destinations/control, video display access, seat memory positions, radio station settings and other parameters that users typically like to adjust when renting a car.

In the example of FIG. 4, server 404 can control the permissions of bit streams received by hotel TV system 410 from multimedia sources 402. Hotel desk 412 can contain an access controller and interface device, such as access controller 214 and interface device 216 of FIG. 2. A user can carry a mobile device 408 comprising the necessary software to display, for example, a quick response (“QR”) code representing an identifier of mobile device 408. However, it is understood that the identifier can also include, but is not limited to, a traditional bar code, color, symbol, and the like. The user can scan the quick response code at the hotel desk 412. In this instance, the access controller can be equipped with a QR code scanner. In an airline related context, the identifier can be communicated by scanning an airline ticket or the identifier can be a seat number. In a rental car setting, the user can also scan the QR code at a front desk.

Referring back to FIG. 3, the identifier can be associated with a multimedia device, as shown in block 304. Referring back to the example of FIG. 4, the dongle 416 can be the multimedia control device and the association between mobile device 408 and dongle 416 can be stored in hotel TV system 410, which can correspond to multimedia content provider system 206 of FIG. 2. Dongle 416 of FIG. 4 is shown attached to the user's in-room TV 414. Once the association is made, the associated mobile device 408 can be permitted to control or transmit commands to dongle 416 directly using a short range wireless protocol or indirectly via hotel TV system 410 using, for example, a Wi-Fi protocol. However, it is understood that additional mobile devices can also be granted permission to control dongle 416 (e.g., such as when a family with multiple devices stays in one room). In an airplane or rental car setting, the multimedia device can be a small multimedia display device. Permissions can also be different for each of the different devices such as controlling certain content access for children and the like.

Referring back to FIG. 3, commands can be executed in the multimedia device based at least partially on commands from the client, as shown in block 306. In FIG. 4, mobile device 408 can display a graphical user interface (“GUI”) that allows a user to change the channel and/or select content for viewing. The GUI can be provided by, for example, the hotel. In turn, the access controller in hotel desk 412 can communicate with hotel TV system 410 to determine the content desired by the user (e.g. change the channel or select content for viewing). A subscription plan or tier structure can be implemented in server 404. For example, an illustrative tier structure can include “free,” “intermediate,” and “premium” options. The free tier can offer content without incurring additional expenses. For example, the free tier can include content from other services, such as YouTube™. The intermediate tier can offer content that will require payment (i.e., “at cost”) if viewed. The intermediate tier can also come with a select number of “at cost” content for free, the free cost being built into the price of the room. Moreover, the premium tier can offer a greater quantity of content, can be more expensive, and can offer the most “at cost” content for free.

Referring now to FIG. 5, an exemplary method from the perspective of a mobile device is shown. In block 502, an identifier can be transmitted via an interface. Referring now to FIG. 6, a different working example 600 is shown that can be implemented in a home setting. In this example, multimedia sources 602 can be streamed to a home gateway 610. Televisions 612, 616, and 620 can be located at different rooms in a home. Each home television set can have a dongle 614, 618, and 622 attached respectively. In other embodiments, circuitry is already present within the television sets and/or set top boxes such that a dongle is not needed. In this system 600, each mobile device can have permissions to stream specific multimedia content from multimedia sources 602 to a particular television. Here, mobile device 624 can transmit its identifier to home gateway 610, which can contain an interface device and an access controller, such as interface device 216 and access controller 214 of FIG. 2. Also, the home gateway 610 can control the permissions within the home in the way that server 404 of FIG. 4 controls the permissions within the hotel (or other environment as described). Finally, home gateway 610 can maintain the associations between mobile devices and dongles/circuitry in the home.

Referring back to FIG. 5, in block 504, an acknowledgement that the identifier is associated with a multimedia control device can be received via the interface. Referring back to FIG. 6, home gateway 610 can acknowledge that the identifier of the mobile device 624 is associated with one or more of the dongles/circuitry connected to or within the home television sets/set top boxes. In another example, mobile device 624 can display a notification that notifies a user of the association between their mobile device and a television/set top box in the home. Such notification can be any type of notification including, but not limited to, a text message or an alert. In block 506 of FIG. 5, commands can be transmitted to the associated multimedia device via the interface. Referring back to FIG. 6, mobile device 624 can transmit commands to an associated dongle/circuitry (e.g., dongles 614, 618, and/or 622) indirectly via home gateway 610. Although not shown, it is understood that mobile device 624 can also transmit commands directly using a short and/or long range wireless protocol. The commands can be any commands related to controlling multimedia. For example, a desired command by the user can be to tune to a “next” or “previous” channel, and/or to “select” content for viewing. Thus, for example, parents can control the programming displayed in each home television so that children can only be permitted to playback parental controlled content via their devices. It is understood that the flow diagram of FIG. 5 can also be applicable in the hotel environment shown in FIG. 4.

Advantageously, the above-described techniques allow users to configure their electronic devices, such as mobile devices, to control any display device. In this regard, users can control, for example, their hotel room TV, at home TV, and any other display by using their mobile devices in place of, for example, a remote control device. In addition, using the techniques herein, hotels, hospitals, nursing homes, and the like can install and maintain VOD systems without the expensive equipment of conventional systems.

Although the present principles herein have been described with reference to particular examples in particular environments, it is to be understood that these examples are merely illustrative of the present principles. It is therefore to be understood that numerous modifications can be made to the examples and that other arrangements can be devised without departing from the scope of the present principles as defined by the appended claims. As noted above, the VOD system herein can be modified to operate in various settings, such as airplanes, cars, hospitals, nursing homes, or any other setting that can offer VOD. Furthermore, while particular processes are shown in a specific order in the appended drawings, such processes are not limited to any particular order unless such order is expressly set forth herein. Rather, various steps can be handled in a different order or simultaneously, and steps can be omitted or added.

1. A system for controlling multimedia content comprising:
an interface device that interacts with client devices; and
an access control device configured to:
detect an identifier associated with a client device, the identifier being received from the client device via the interface device;
associate the identifier with a multimedia device to control multimedia content; and
execute commands in the multimedia device based at least partially on commands received from the client device by the interface device.

2. The system of claim 1, wherein the multimedia device is a dongle connected to a display device.

3. The system of claim 1, wherein the access control device is further configured to select the multimedia device that will be associated with the identifier.

4. The system of claim 1, wherein the access control device is further configured to communicate with a server to determine and configure client device access permissions for multimedia content.

5. The system of claim 1, wherein the access control device is configured to scan, via the interface device, a quick response code displayed by the client device in order to detect the identifier.

6. An apparatus for controlling multimedia content comprising:
an interface device to communicate with a client device; and
at least one processor configured to:
detect an identifier associated with the client device, the identifier being received from the client device via the interface;
associate the identifier with a multimedia device to control multimedia content; and
configure the multimedia device to accept multimedia control commands from the client device.

7. The apparatus of claim 6, wherein the multimedia device is a dongle connected to a display device.

8. The apparatus of claim 6, wherein the at least one processor is further configured to select the multimedia device that will be associated with the identifier.

9. The apparatus of claim 6, wherein the at least one processor is further configured to communicate with a server to determine and configure client device access permissions for multimedia content.

10. The apparatus of claim 6, wherein the at least one processor is further configured to scan a quick response code displayed by the client device in order to detect the identifier.

11. A method comprising:
communicating with a client device using an interface device;
detecting, by at least one processor, an identifier associated with the client device, the identifier being received from the client device via the interface device;
associating, by the at least one processor, the identifier with a multimedia device to control multimedia content; and
executing, by the at least one processor, commands in the multimedia device based at least partially on commands received from the client device by the interface device.

12. The method of claim 11, wherein the multimedia device is a dongle connected to a display device.

13. The method of claim 11, further comprising:
selecting, by the at least one processor, the multimedia device that is associated with the identifier.

14. The method of claim 11, further comprising:
communicating, by the at least one processor, with a server to determine and configure client device access permissions for multimedia content.

15. The method of claim 11, wherein detecting the identifier further comprises scanning, by the at least one processor, a quick response code displayed by the client device.

16. An apparatus comprising:
an interface device for communicating multimedia control information; and
at least one processor configured to:
transmit, via the interface device, to an access controller an identifier associated with the apparatus;
receive, via the interface device, an acknowledgement that the identifier is associated with a multimedia device; and
transmit, via the interface device, commands to the associated multimedia device via the access controller.

17. The apparatus of claim 16, wherein the multimedia device is a dongle connected to a display device.

18. The apparatus of claim 16, wherein the at least one processor is further configured to select the multimedia device that will be associated with the identifier.

19. The apparatus of claim 16, wherein the at least one processor is further configured to display a quick response code indicative of the identifier associated with the apparatus.

20. A method comprising:
transmitting, by at least one processor, an identifier associated with a client device to an access controller;
detecting, by the at least one processor, an acknowledgement from the access controller that the identifier is associated with a multimedia device; and
transmitting, by the at least one processor, commands to the associated multimedia device via the access controller.

21. The method of claim 20, wherein the multimedia device is a dongle connected to a display device.

22. The method of claim 20, further comprising selecting, by the at least one processor, the multimedia device that will be associated with the identifier.

23. The method of claim 20, further comprising displaying, by the at least one processor, a quick response code indicative of the identifier associated with the client device.
